(19) United States
(12) Patent Application Publication
(10) Pub. No.: US 2009/0063266 A1
(43) Pub. Date: Mar. 5, 2009

(54) PERFORMING OF MARKETING ACTIONS WHILE PRESERVING CONFIDENTIALITY

(75) Inventors: Robert F. Blanch, Redmond, WA (US); Ana Martha Lopez, Sammamish, WA (US); Erica Y. Chang, Redmond, WA (US); Samir Bajaj, Redmond, WA (US); Srinivasan Parthasarathy, Redmond, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/849,877

(22) Filed: Sep. 4, 2007

(51) Int. Cl. G06Q 30/00

(52) U.S. Cl. 705/14; 705/1

(57) ABSTRACT

A system provides targeted advertising to customers of an application while preserving the confidentiality of the customers' application information. A marketing system provides a marketing engine that executes on a computer system of the customer of an application and provides targeted marketing to that customer. Since the marketing engine executes on the customer's own computer system, it may have access to the customer's application information. The marketing engine can analyze the application information and provide marketing information that is targeted to the customer without compromising the confidentiality of the customer's application information.

### BACKGROUND

Computer programs, referred to as applications, may provide a wide variety of features. For example, an accounting application may implement accounting features such as a payroll feature, a banking feature, an expense tracking feature, an accounts payable feature, an accounts receivable feature, a reporting feature, and so on. Each of these features may be implemented in different modules of the application. In addition, the accounting application may provide features that allow a customer to register for various services such as payroll processing. Many applications can be configured to provide a set of features that is appropriate for each customer's needs. For example, an owner of a small business may need an accounts payable feature and accounts receivable feature, but may not need a payroll feature because the owner may be the only employee of the business. Application providers (e.g., vendor or developer) may base the pricing of their applications on the features selected by their customers. So, a customer who needs all the features of the application would pay a higher price than a customer who only needs two features.

To increase their profits, application providers would like their customers to select and purchase as many features of their applications as reasonably possible. Application providers employ various marketing techniques to encourage new customers and current customers to purchase additional features. Application providers often employ non-targeted marketing techniques to market their applications. These marketing techniques may include advertising through traditional channels (e.g., magazines, newspapers, and televisions) and non-traditional channels (e.g., sponsored links of search engines and pop-up windows of web pages). Such marketing techniques are non-targeted in the sense that all current customers or potential customers are provided with the same marketing information regardless of what features current customers have purchased or potential customers may need.

Because non-targeted marketing may be expensive and not particularly effective, application providers would like to use targeted marketing that tailors the marketing to the needs of the current customer or the potential customer. For example, an application provider of an accounting application may want to advertise its payroll module to current customers that have not purchased the payroll module and that have a need for a payroll module (e.g., several employees). Since applications generally store customer information, and more generally application information, in an application database or application store, sufficient information may already be stored electronically to support such targeted marketing. Application providers, however, typically do not have access to such application information because customers generally consider such application information to be highly confidential.

### SUMMARY

A system provides targeted advertising and personalized assistance to customers of an application while preserving the confidentiality of the customers' application information. A marketing system provides a marketing engine that executes on a computer system of the customer of an application and provides targeted marketing to that customer. Since the marketing engine executes on the customer's own computer system, it may have access to the customer's application information. The marketing engine can analyze the application information and provide marketing information that is targeted to the customer without compromising the confidentiality of the customer's application information.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating components of the marketing system in some embodiments.

FIG. 2 is a block diagram that illustrates a logical organization of a marketing plan store in some embodiments.

FIG. 3 is a flow diagram that illustrates processing of an update marketing plan component of the marketing system in some embodiments.

FIG. 4 is a flow diagram that illustrates processing of the process event component of the marketing system in some embodiments.

FIG. 5 is a flow diagram that illustrates the processing of the check subscription filter component of the marketing system in some embodiments.

FIG. 6 is a flow diagram that illustrates the processing of the check subscription conditions component of the marketing system in some embodiments.

### DETAILED DESCRIPTION

A system for providing targeted advertising to customers of an application while preserving the confidentiality of the customers' application information is provided. In some embodiments, a marketing system provides a marketing engine that executes on a computer system of the customer of an application and provides targeted marketing to that customer. Since the marketing engine executes on the customer's own computer system, it may have access to the customer's application information. The marketing engine can analyze the application information and provide marketing information that is targeted to the customer. Since the marketing engine executes on a customer's computer system, the customer's application information need not be provided to another computer system that is responsible for deciding how to market to that customer. Thus, the confidentiality of the customer's application information can be preserved by the marketing system.

In some embodiments, the marketing system may dynamically download marketing plans to customer computer systems for execution by the marketing engine. To support dynamic marketing plans, the marketing system includes client-side components that execute on the customer computer systems (or “client”) and server-side components that execute on a server of the application provider. The client-side components may include a marketing engine and an update marketing plan component, and the server-side components may include marketing tools for developing and distributing marketing plans to customer computer systems. An application provider uses the marketing tools of the server-side component to generate a marketing plan. The update marketing plan component may periodically access the server to download the current marketing plan. After downloading the current marketing plan, the marketing engine markets to the customer in accordance with the marketing plan. For example, the marketing plan may specify that an advertisement for a payroll module should be displayed every fifth time a customer starts up the application when the customer does not have the payroll module and has more than 10 employees. Although a marketing engine could implement a static marketing plan that is delivered when a customer purchases an application, such a static marketing plan will not be able to adapt to the changing marketing needs of an application provider. For example, an application provider may develop new features for its application after the application is installed on a customer's computer system. A static marketing plan, however, may not be able to effectively market that new feature to the customer. Because the marketing system dynamically downloads marketing plans, an application provider who develops new features can adjust its market plans accordingly.

In some embodiments, the marketing system represents a marketing plan as a collection of subscriptions with each subscription identifying an event, a condition, and an action. The subscriptions specify marketing actions that the marketing engine should perform when various conditions are satisfied. The event of a subscription specifies an event that occurs during execution of the application indicating that the subscription should be applied. For example, an event may specify that the user of the application launches a certain module of the application. When the event identified in a subscription occurs, the marketing engine applies the subscription by determining whether the condition of that subscription is satisfied and if so, performs the action of the subscription. For example, the condition may be that the application information indicates that the customer has more than 10 employees. The condition generally relates to the customer's application information but can be other information that is not specific to the application (e.g., current version of the operating system). If the condition is satisfied, the marketing engine performs (or directs the performance of) the action identified by that subscription. For example, the action may be to display an advertisement suggesting that the customer purchase a payroll module. Each subscription may also identify a filter that needs to be passed before the condition of the subscription is evaluated. A filter is used to control the frequency at which the action of a subscription is performed, the number of times the action is performed, the expiration of the subscription, and so on. For example, a filter of a subscription may specify to evaluate the condition only every fifth time the event occurs. A filter may also specify that certain state information or application context (e.g., user preferences such as no pop-up windows) needs to be satisfied before the filter is passed. The state information may include the version number of the application.

The marketing engine may register to receive event notifications for various events that occur during execution of the application. The application may include an event manager that implements a publisher/subscriber event notification model. When the marketing engine receives an event notification, it identifies those subscriptions of the current marketing plan that match the event that just occurred. An event notification may include an event type and an event value. A subscription identifies one or more event type and event value combinations. After identifying the subscriptions that match the event, the marketing engine determines which matching subscriptions pass their filters. The marketing engine then determines whether the conditions of those passing subscriptions are satisfied. When the marketing engine determines that a condition of a subscription is satisfied, the marketing engine then causes the action of the satisfied subscription to be performed.

The client-side components of the marketing system may include an update marketing plan component that is responsible for downloading new marketing plans from the server and storing the marketing plans on the customer's computer system. The update marketing plan component may check a server of the application provider periodically or on occurrence of certain events to determine whether new marketing plans have been developed. A single marketing plan may be developed for all customers of an application, or different marketing plans may be developed for different customers or users or different classes of customers or users. For example, an application provider may develop a marketing plan for customers that manufacture clothing and another marketing plan for customers that sell clothing at the retail level. The update marketing plan component may download the marketing plan that is appropriate for the customer.

The update marketing plan component may store the downloaded marketing plan in a marketing plan store that contains the current marketing plan. A marketing plan may include renewed subscriptions that were included in the previous marketing plan, include new subscriptions not included in the previous marketing plan, and omit not renewed subscriptions included in the previous marketing plan but that are not in the new marketing plan. To help track whether a subscription is renewed, new, or not renewed, the marketing system may assign a unique identifier to each subscription. When storing a new marketing plan, the update marketing plan component compares the identifiers of the subscriptions of the new marketing plan to the identifiers of the subscriptions in the previous marketing plan. When the update marketing plan component determines that a subscription of the new marketing plan is new, the update marketing plan component stores that subscription in the marketing plan store. When the update marketing plan component determines that a subscription of the new marketing plan is being renewed, the update marketing plan component leaves the subscription of the marketing plan store unchanged. The marketing plan store may contain information for tracking the frequency of performing the action identified in the subscription. In such a case, the update marketing plan component maintains such information by not replacing the subscription in the marketing plan store. When the update marketing plan component determines that a subscription of the previous marketing plan is not being renewed, then it removes that subscription from the marketing plan store.

The marketing system may be adapted to perform actions for applications that are directly related to marketing of the application. For example, a subscription may be developed that detects when a user is using the application inefficiently and suggests a more efficient way to use the application. As an example, a user may enter a column of numbers in cells of a spreadsheet, then enter a “sum” function in a cell at the bottom of the column, and manually specify the top and bottom cells of the column as the range for the “sum” function. A subscription may have a condition that is satisfied when the user performs such entering of the “sum” function at the bottom of columns a certain number of times. The action of the subscription may be to display a dialog box that suggests that the user use a sigma icon “Σ”, which automatically enters the “sum” function for the appropriate range of cells.

The following table outlines fields of the subscription store in some embodiments.

| Field | Data Type | Description |
|---|---|---|
| Sku | int | Identifies the application to which this subscription |
| | | applies |
| EventType | nvarchar(512) | Specifies the event type (e.g., open a form, print a |
| | | check) |
| EventValue | nvarchar(512) | Specifies a value associated with the event (e.g., for |
| | | an open form event, the value may specify the type |
| | | of form that is being opened) |
| Count | int | Count of the number of matching events that have |
| | | occurred since this subscription was downloaded |
| TriggerCount | int | Specified the number of times a matching event is to |
| | | occur before performing the action the first time |
| SnoozeSkipCount | int | Specifies how many times the matching event |
| | | occurs between checking the condition of the |
| | | subscription |
| Action | int | Specifies the action |
| string1-string5 | nvarchar(512) | Optional parameters for the action (e.g., the URL to |
| | | use when the action is launching of a browser) |
| Expiration | datetime | Expiration of the subscription |
| MaxShowCount | int | Maximum number of times the action of the |
| | | subscription is to be performed |
| ShowCount | int | Number of times the action of the subscription has |
| | | been performed |
| Reminder | bit | Records whether the user requested to have this |
| | | action performed later |

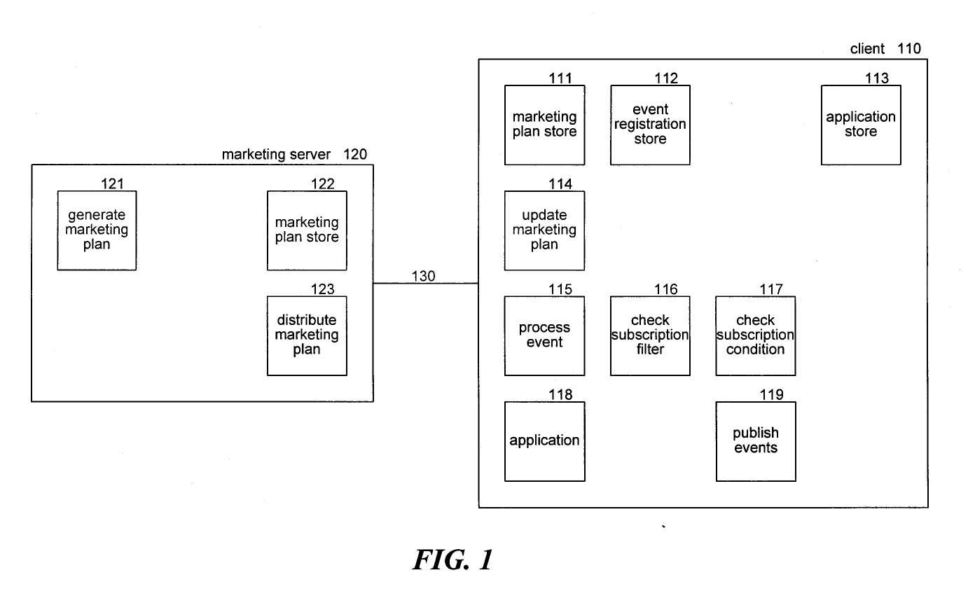

FIG. 1 is a block diagram illustrating components of the marketing system in some embodiments. The marketing system includes client-side components that execute on a customer's client 110 and interacts with server-side components that execute on a marketing server 120 via communication link 130. The client may include a marketing plan store 111, an event registration store 112, and an application store 113. The marketing plan store contains the subscriptions of the current marketing plan. The event registration store contains an indication of the events for which the marketing engine wants to receive notification. The application store contains application information of an application 118 that includes information that is confidential to the customer. The client-side components include an update marketing plan component 114 and a marketing engine that includes a process event component 115, a check subscription filter component 116, and a check subscription conditions component 117. The client may also include a publish events component 119 that detects when application events occur and notifies the marketing engine when it has registered to receive notifications of those events as indicated by the event registration store. The update marketing plan component is responsible for downloading marketing plans from the marketing server and updating the marketing plan store with the new marketing plans. The process event component is invoked to process event notifications. The process event component identifies whether subscriptions match an event and invokes the check subscription filter component and the check subscription conditions component to determine whether to perform the action associated with the subscription.

The marketing server has server-side components that include a generate marketing plan component 121, a marketing plan store 122, and a distribute marketing plan component 123. An application provider interacts with the generate marketing plan component to generate a marketing plan which is stored in the marketing plan store. The distribute marketing plan component receives requests to download the current marketing plan from customer computer systems and transmits the appropriate marketing plans to the customer computer systems.

The computing device on which the marketing system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the marketing system, which means a computer-readable medium that contains the instructions. In addition, the instructions, data structures, and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in and used with various operating environments that include personal computers, server computers, hand-held or laptop devices, multiprocessor systems, microprocessor-based systems, programmable consumer electronics, digital cameras, network PCs, minicomputers, mainframe computers, computing environments that include any of the above systems or devices, and so on.

The marketing system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

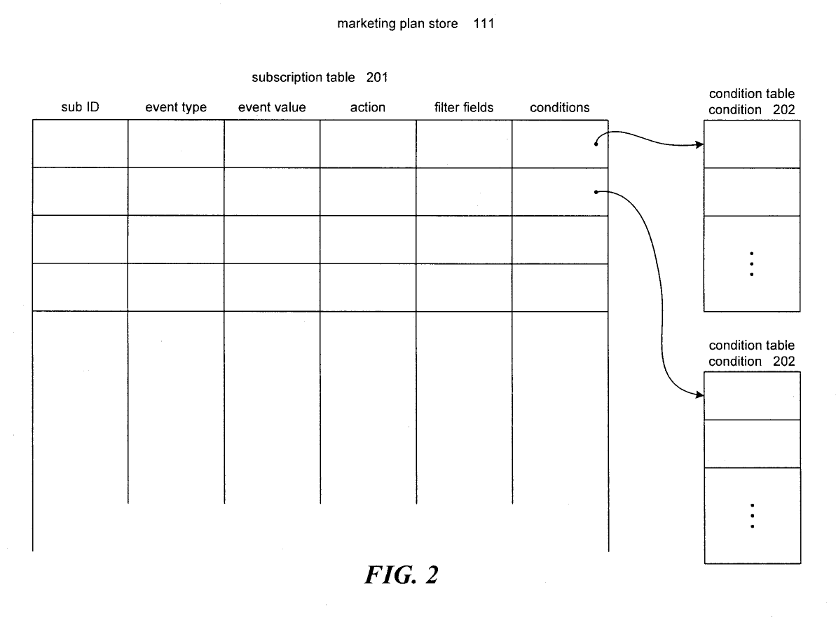

FIG. 2 is a block diagram that illustrates a logical organization of a marketing plan store in some embodiments. The marketing plan store 111 may include a subscription table 201 with an entry for each subscription of the current marketing plan. Each entry contains the fields of the subscription (e.g., fields relating to filtering) along with a reference to a condition table 202. Each condition table contains entries specifying conditions of the corresponding subscription.

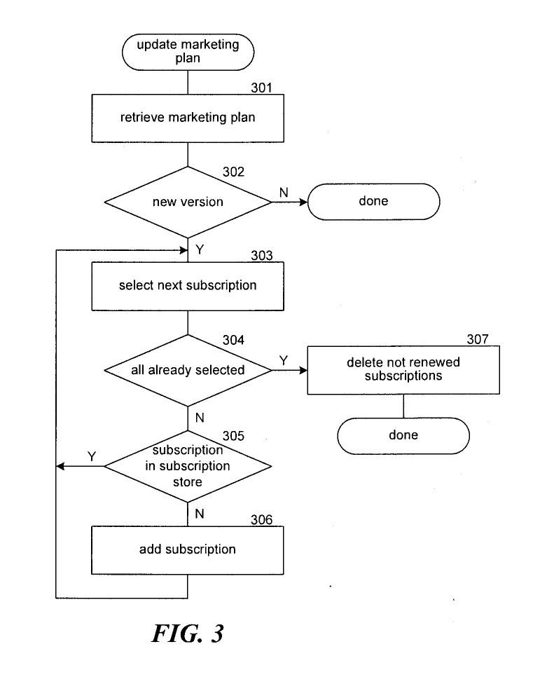

FIG. 3 is a flow diagram that illustrates processing of an update marketing plan component of the marketing system in some embodiments. The component is a client-side component that downloads marketing plans from the marketing server and stores the subscriptions of the marketing plans in a subscription store. In block 301, the component receives the current marketing plan from the marketing server. In block 302, if the marketing plan is new, then the component continues at block 303, else the component completes. In blocks 303-306, the component loops updating the marketing plan store as appropriate for each subscription of the marketing plan. In block 303, the component selects the next subscription of the new marketing plan. In decision block 304, if all the subscriptions have already been selected, then the component continues at block 307, else component continues at block 305. In decision block 305, if the selected subscription is already in the marketing plan store, then the subscription is being renewed and the component loops to block 303 to select the next subscription, else the component continues at block 306. In block 306, the component adds the selected subscription, which is a new subscription, to the marketing plan store and then loops to block 303 to select the next subscription of the new marketing plan. In block 307, the component deletes subscriptions from the subscription store that had not been renewed by the new marketing plan. The component then completes. Although not illustrated in the flow diagram, the component may also register and unregister to receive application events for new and not renewed subscriptions as appropriate.

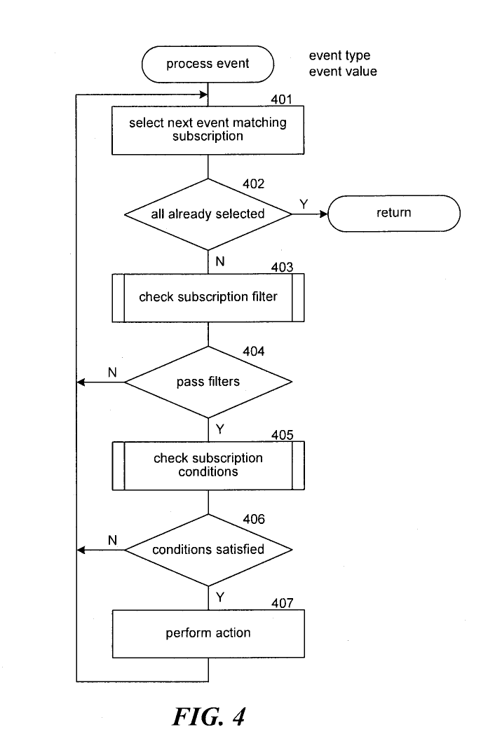

FIG. 4 is a flow diagram that illustrates processing of the process event component of the marketing system in some embodiments. The component is a client-side component that is invoked to process event notifications. The component is passed an event type and an event value. In blocks 401-407, the component loops identifying subscriptions of the marketing plan store that match the event. In block 401, the component selects the next subscription of the marketing plan store that matches the event. In some embodiments, the marketing plan store may be indexed on event type to facilitate selection of subscriptions that match an event. In decision block 402, if all the matching subscriptions have already been selected, then the component returns, else the component continues at block 403. In block 403, the component invokes a check subscription filter component to determine whether the filter of the selected subscription has been passed. In decision block 404, if the filter has passed, then the component continues at block 405, else the component loops to block 401 to select the next matching subscription. In block 405, the component invokes the check subscription conditions component to determine whether the conditions of the selected subscription are satisfied. In decision block 406, if the conditions are satisfied, then the component continues at block 407, else the component loops to block 401 to select the next matching subscription. In block 407, the component performs the action associated with the selected subscription and then loops to block on 401 to select the next matching subscription. Although not illustrated in the flow diagram, the component updates the various fields of the subscription store needed for filtering.

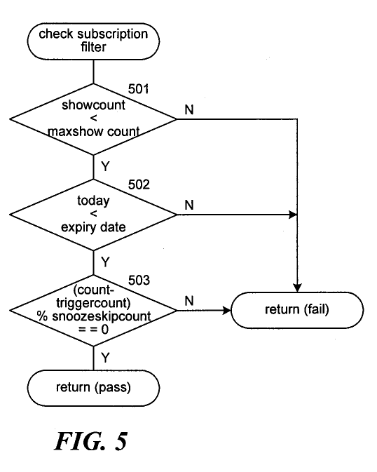

FIG. 5 is a flow diagram that illustrates the processing of the check subscription filter component of the marketing system in some embodiments. The component determines whether a subscription passes its filter. In decision block 501, if the number of times the action of the subscription has been performed is less than the maximum number, then the component continues at block 502, else the component returns an indication that the subscription has not passed its filter. In decision block 502, if today's date is earlier than the expiration date of the subscription, then the component continues at block 503, else the component returns an indication that the subscription did not pass its filter. In decision block 503, if the count of matching events indicates that it is time to check the condition of the subscription, then the subscription has passed its filter, else the component returns an indication that the subscription did not pass its filter.

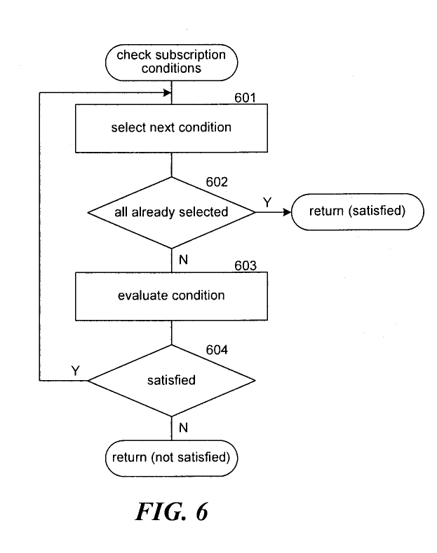

FIG. 6 is a flow diagram that illustrates the processing of the check subscription conditions component of the marketing system in some embodiments. The component determines whether the conditions of a subscription are satisfied. In blocks 601-604, the component loops checking whether each condition of the subscription is satisfied. In block 601, the component selects the next condition of the subscription. In decision block 602, if all the conditions of the subscription have already been selected, then the component returns an indication that the conditions of the subscription are satisfied, else the component continues at block 603. In block 603, the component evaluates the selected condition to determine whether it is satisfied. In decision block 604, if the condition is satisfied, then the component loops to block 601 to select the next condition, else the component returns an indication that the conditions of the subscription are not satisfied.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, the marketing actions can including displaying of advertisements for the application, displaying a dialog box allowing a user to upgrade the application, displaying of pop-up windows, displaying a panel containing multiple advertisements or cycling through multiple advertisements (e.g., when the conditions of multiple subscriptions are satisfied), and so on. Accordingly, the invention is not limited except as by the appended claims.

I/We claim:

1. A method in a computing device for performing marketing actions associated with an application executing on the computing device, the marketing actions tailored to application information of the application while preserving the confidentiality of the application information, the method comprising:
receiving a marketing plan from a marketing server, the marketing plan having subscriptions that each identify an event, a condition, and an action;
storing the received subscriptions of the received marketing plan in a marketing plan store; and
when an event is generated from execution of the application,
identifying subscriptions of the marketing plan store that match the event;
evaluating conditions of the identified subscriptions based on the application information;
selecting the identified subscriptions whose conditions are satisfied as indicated by the evaluations; and
performing the actions associated with the selected subscriptions wherein the application information used to evaluate the conditions is not
disclosed outside the computing system to implement the marketing plan.

2. The method of claim 1 wherein each subscription identifies a filter and wherein the evaluating of the condition of a subscription is performed only when its filter is passed.

3. The method of claim 2 wherein the filter is based on frequency of occurrence of the event.

4. The method of claim 2 wherein the filter is based on state information of the application.

5. The method of claim 1 wherein a subscription has an event type and an event value and the subscription matches an event with the same event type and event value.

6. The method of claim 1 wherein the events are generated based on user interactions with the application.

7. The method of claim 1 wherein the action of a subscription is displaying of an advertisement relating to the event.

8. The method of claim 1 wherein the action of a subscription is displaying of a dialog for upgrading of the application.

9. The method of claim 1 wherein the marketing server sends the same subscriptions to a plurality of computing devices and the selecting of subscriptions is based on the application information of each computing device.

10. A computer-readable medium embedded with computer-executable instructions for controlling a computing device to perform actions associated with an application executing on the computing device, by a method comprising:
receiving subscriptions from a marketing server, each subscription identifying an event, a filter, a condition, and an action;
storing the received subscriptions in a marketing plan store; and
when an event is generated from execution of the application,
identifying subscriptions of the marketing plan store whose events match the generated event and that pass their filters;
evaluating conditions of the identified subscriptions based on application information associated with the application, the application information not being disclosed to the marketing server;
selecting the identified subscriptions whose conditions are satisfied as indicated by the evaluations; and
performing the actions associated with the selected subscriptions.

11. The computer-readable medium of claim 10 wherein passing the filter is based on a context of the application.

12. The computer-readable medium of claim 11 wherein the context indicates a user's preference relating to performing of actions.

13. The computer-readable medium of claim 11 wherein the context relates to past occurrences of the event that matches a subscription.

14. The computer-readable medium of claim 10 wherein the application is an accounting application and the application information includes customer information.

15. The computer-readable medium of claim 10 wherein the marketing server sends the same subscriptions to a plurality of computing devices and the selecting of subscriptions is based on the application information of each computing device.

16. The computer-readable medium of claim 10 wherein a subscription has an event type and an event value and the subscription matches an event with the same event type and event value.

17. The computer-readable medium of claim 10 wherein the received subscriptions are periodically downloaded from the marketing server.

18. A computing device that presents advertisements relating to an application executing on the computing device, comprising:
an application store that contains information relating to the application;
an update subscription component that retrieves subscriptions from a subscription server and stores the retrieved subscriptions in a marketing plan store, each subscription specifying an event, a condition, and an advertisement; and
a process event component that receives notifications of occurrences of events, identifies the subscriptions whose events match the notification, selects the identified subscriptions whose conditions are satisfied by application information of the application, and displays the advertisements of the selected subscriptions
wherein the marketing plan server is not provided with the application information of the application used to evaluate the conditions.

19. The computing device of claim 18 wherein each subscription specifies a filter that indicates frequency of displaying the advertisement of the subscription.

20. The computing device of claim 18 wherein the update subscription component retrieves a collection of subscriptions from the marketing server, adds new subscriptions to the subscription store, and removes not renewed subscriptions from the marketing plan store.
